(19) United States
(12) Patent Application Publication
(10) Pub. No.: US 2017/0124177 A1
(43) Pub. Date: May 4, 2017

(54) Method and system for locating underlying patterns in datasets using hierarchically structured categorical clustering

(71) Applicant: David Mele Rimshnick, Queens, NY (US)

(72) Inventor: David Mele Rimshnick, Queens, NY (US)

(21) Appl. No.: 15/236,402

(22) Filed: Aug. 13, 2016

Related U.S. Application Data
(60) Provisional application No. 62/249,739, filed on Nov. 2, 2015.

(51) Int. Cl. G06F 17/30

(52) U.S. Cl. CPC G06F 17/30598; G06F 17/30377; G06F 17/30589

(57) ABSTRACT

Method and system for locating underlying patterns in datasets using hierarchically structured categorical clustering is disclosed. This invention addresses the specific problem of locating, describing, and ranking all relevant performance factors in a dataset of any size and kind, thus producing much more complete and accurate results than any existing procedure.

### BACKGROUND OF THE INVENTION

### Problem Solved

Organizations have very limited automatic tools to systematically isolate performance factors in vast data sets. Countless resources and man-hours are invested, yet significant trends often go undetected when employing traditional data analytics means. With incomplete information and analyses, organizations can miss opportunities to foster areas of accomplishment, or delay addressing emerging problems, to the detriment of their success.

Current data mining techniques do not even attempt to automatically execute a process for locating, describing, and ranking all relevant performance patterns and clusters in a given dataset.

This invention addresses the specific problem of locating, describing, and ranking all relevant performance factors in a dataset of any size and kind, thus producing much more complete and accurate results than any existing procedure.

### BRIEF DESCRIPTION OF THE DRAWINGS

FIG. 1 is a schematic description of a computer system in accordance with one embodiment of the present invention.

FIG. 2 is a flow diagram of a module for clustering data in accordance with one embodiment of the present invention.

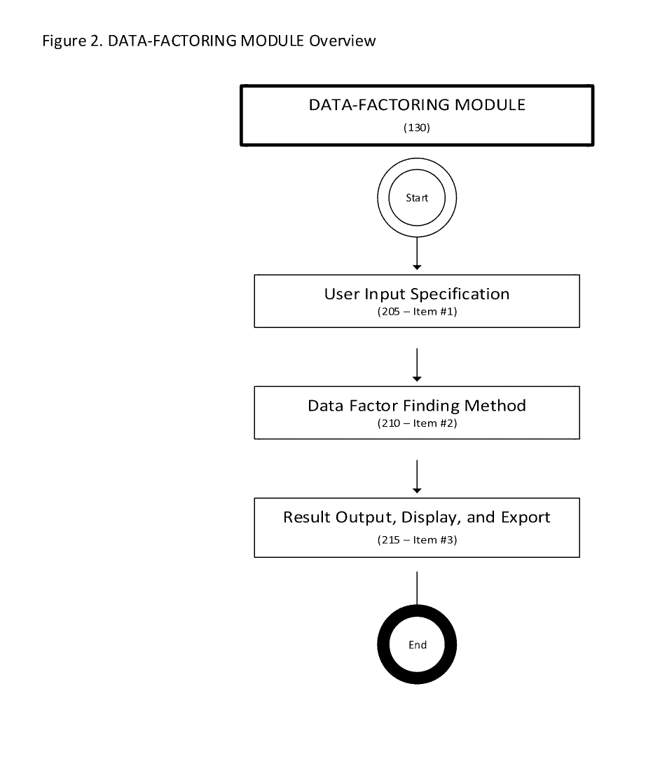

FIG. 3 is a flow diagram of the user input specification in accordance with one embodiment of the present invention.

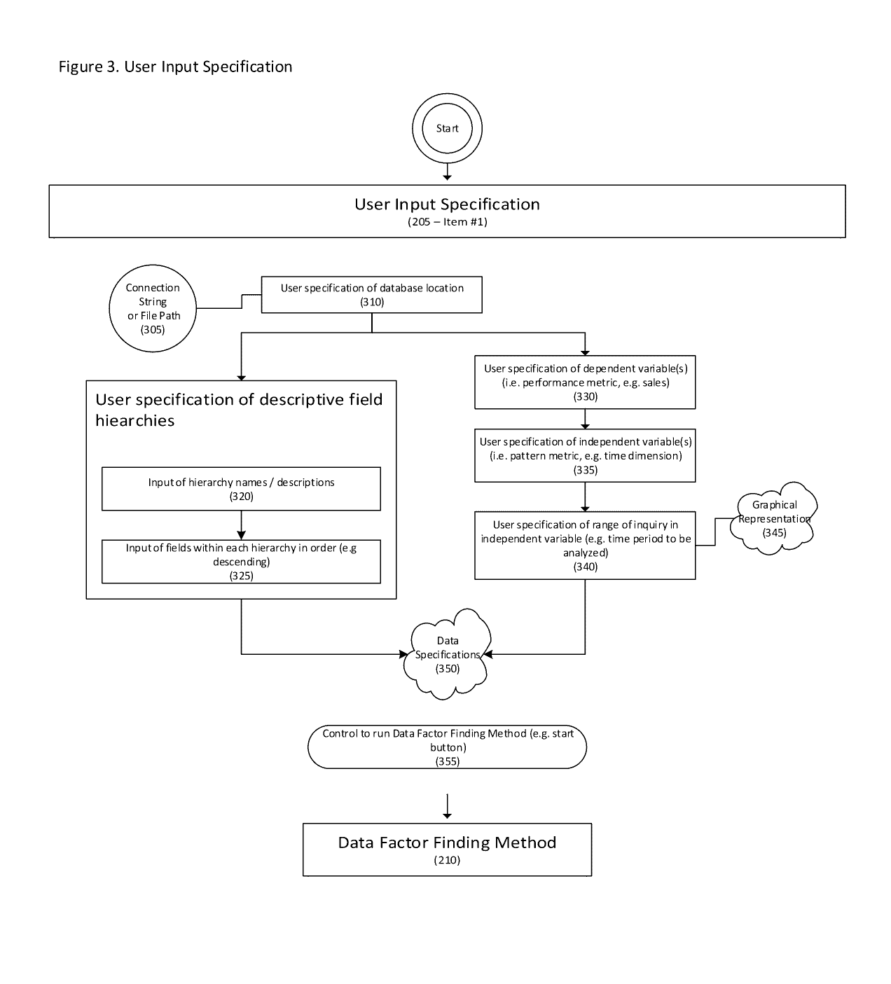

FIG. 4 is a flow diagram of the data factor finding method in accordance with one embodiment of the present invention.

FIG. 5 is a flow diagram of the result output, display, and export methods in accordance with one embodiment of the present invention.

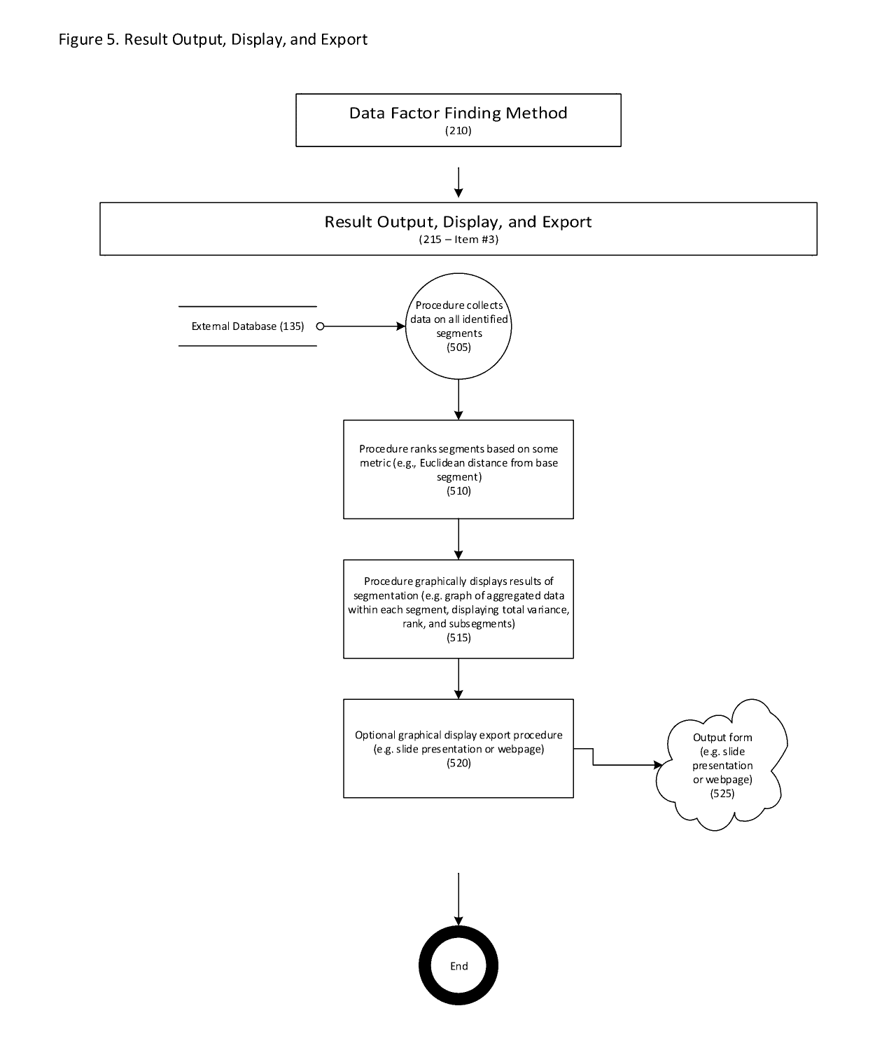

FIG. 6 is an example output of a discovered factor within a dataset in accordance with one embodiment of the present invention.

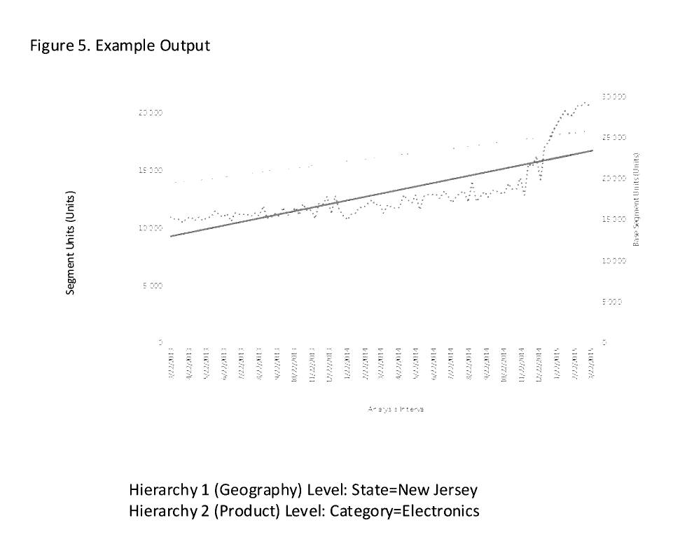

### DETAILED DESCRIPTION OF THE INVENTION

As stated above, organizations have very limited automatic tools to systematically isolate performance factors in vast data sets. Countless resources and man-hours are invested, yet significant trends often go undetected when employing traditional data analytics means. With incomplete information and analyses, organizations can miss opportunities to foster areas of accomplishment, or delay addressing emerging problems, to the detriment of their success. The invention claimed here solves this problem.

This invention uses a novel computer process to dig deep into vast datasets of any kind across large numbers of dimensions. Users will be able to easily and automatically extract key business trends and performance clusters to allow for immediate interpretation and action. Significant trends that are hidden when looking at the overall dataset will emerge.

The claimed invention differs from what currently exists. This invention improves upon a myriad of manual and incomplete procedures, and not only saves time and resources but also executes the analysis more accurately and comprehensively.

These systems do not work because they do not address this specific problem, and thus their results are at best very incomplete, and in many cases can be misleading. This invention focuses on identifying clusters based on hierarchical/categorical information, as opposed to merely identifying structural features in the data. A key output from this invention is the specific, precise description of the location of these found clusters (aka segments), as described by the specific level and label within each specified hierarchy.

This invention addresses the specific problem of locating, describing, and ranking all relevant performance factors in a dataset of any size and kind, thus producing much more complete and accurate results than any existing procedure.

This invention, as previously stated, can potentially produce summary data for external presentation, such as images, graphs, and data to be used in presentations or webpages.

### The Version of the Invention Discussed Here Includes

1. User Input Specification

2. Data Factor Finding Method

3. Result Output, Display, and Export

4. Computer System

### Relationship Between the Components

Item #1, the User Input Specification (labeled 205 on the diagrams), collects data about the dataset to be analyzed and its fields, including specification of the fields to be examined and their internal relationship.

Item #2, the Data Factor Finding Method (labeled 210 in the diagram), uses a novel process to identify the clusters of behavior within the dataset specified in Item #1 according to the structure defined in Item #1.

Item #3, the Result Output, Display, and Export procedure (labeled 215 in the diagrams), takes the results of Item #2 and displays them in graphical and textual formats and has ability to exports the results for further analysis and presentation.

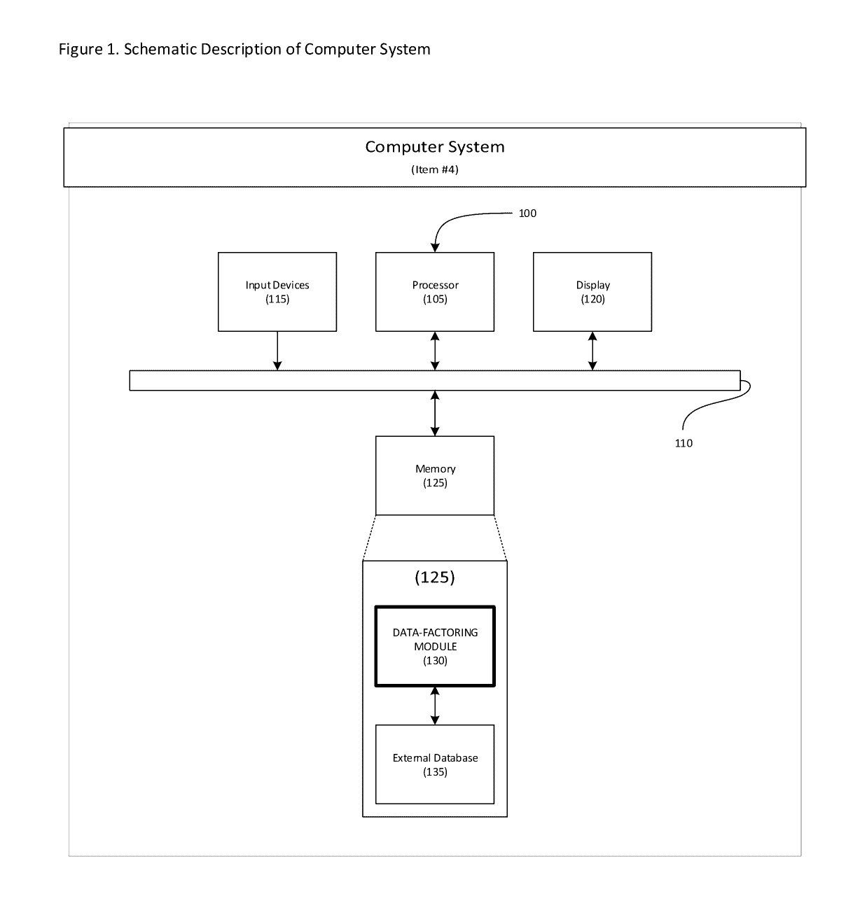

Item #4 is the computer system, which is a particular illustrative embodiment of the invention. The DATA-FACTORING MODULE shown in the diagram (see FIG. 1), of which Items 1-3 are a part, is stored in the memory of the computer system. The memory also has access to the External Database (135). This computer system would have access to a processor of some sort (single or multi), and potentially input devices such as a mouse and keyboard, and also output devices such as a monitor and printer. This system may be implemented in various operating environments. The operating environment described herein is only one example of a suitable operating environment. It is not intended to suggest any limitation as to the scope of use or functionality of the factor-finding system. Other commonly known computing systems, environments, and configurations that may be suitable for use include mobile devices, personal computers, server computers, hand-held or laptop devices, multiprocessor systems, microprocessor-based systems, programmable consumer electronics, network PCs, minicomputers, mainframe computers, distributed or cloud computing environments that include any of the above systems or devices, and the like.

### How the Invention Works

Item #1, the user input specification (labeled 205 on the diagrams), takes in specific information used to start the process. In an illustrative environment, this would include the connection string or file path to the database; specification of the dependent variable to be studied (such as sales); the independent variable over which the pattern is to be compared (e.g. time); the range of inquiry of that independent variable (e.g. specific time period).

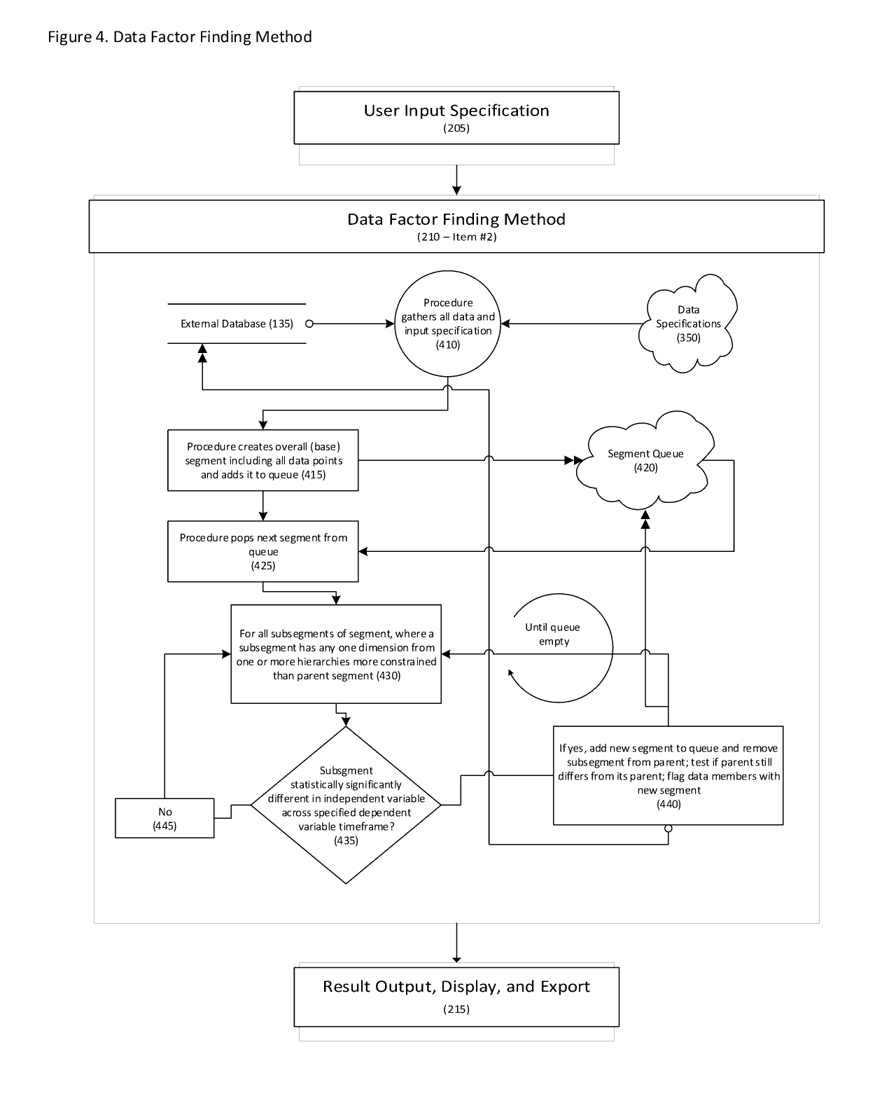

Item #2 (labeled 210 in the diagram), in one illustrative embodiment, uses the input from Item #1 to determine statistically relevant clusters of data points (members of the dataset). It does this through the logical process described below and in FIG. 4. The process begins by creating an overall segment containing all of the data (base segment). From there, potential sub-segments are identified by constraining a field from one or more hierarchies to a greater extent than in the parent, and testing whether this sub-segment should be identified as its own segment, as described below. (Note that the described testing procedure may be implemented in a variety of ways based on various metrics and statistical techniques; this is just one illustrative example.) The process continues until all sub-segments have been tested for all segments identified. The final step, item #3 (labeled 215 in the diagram), in one embodiment displays the results of the segmentation in graphical and textual formats for user consumption. Potential variables displayed include the independent variable graphed against the dependent variable over some interval, segment rank (where segment is ranked by, for example, Euclidean distance from base segment), distance from base segment, and excluded sub-segments. The description of the segment would also be included, indicating the level specification of the segment within each hierarchy and the appropriate label on that level of the hierarchy. The results of the process could also potentially be exported to an outside display, such as a slide presentation or webpage.

The main logical step in the process is the determination of whether a potential sub-segment of each segment should be considered its own independent segment or left as a member of its parent (see item labeled 435 in the diagram). This comparison is done by testing for a statistically significantly different pattern, e.g. by Euclidean distance in normalized values, between the potential sub-segment and its parent. If this test comes back true, the sub-segment is removed from the parent and deemed a new segment, and all its members are relabeled to be members of this new segment. If not, the process simply continues looking at all potential sub-segments of all existing segments, until the list is exhausted.

### How to Make the Invention

To make this invention, one must craft software that is able to complete the requisite tasks and provide the user with the useful tool described here above.

In standard practice, Items #1 and #2 are necessary, while #3 is optional but useful. Item #1 could be augmented by automatic identification and labeling of fields by using some external data or metadata, for example. One could also imagine saving all or part of this data for later use, so that it would not have to be entered upon each instantiation of the program.

Another such improvement would be a module to specify that the procedure should only work on a selected subset of the data (with filters specified or recommended, for example). This would allow different users to look at different parts of the dataset to find lower-level patterns, for example.

Another potential addition would be a module for automatically executing this process for given time periods; e.g. automatically running over each week or quarter.

As mentioned previously, parts of Item #1 can be themselves automated or stored for later use. The independent variable range specification can be automated, or each potential range can be tested and results aggregated for comparison sake. Also, other, non-categorical variables, such as numeric variables, could be included as categorical variables if there is a process in place to automatically or manually create categorical variables from these non-categorical variables.

One can imagine Item #2 being performed in a continuous manner rather than an ad hoc basis, with results being updated continuously based on changing data patterns. For instance, each sub-segment can be continuously tested against its parent to see if its difference becomes significant over time.

Other methods may attempt to execute this process in a different order or using different parameters. For example, one can imagine potentially specifying a segment to be studied, and a time period being automatically identified during which that segment is relevant.

Also, as mentioned previously, various statistical techniques and other well-known algorithms may be used for the logical tests between parent and sub-segments, of which we have only specified an illustrative example.

### How to Use the Invention

A person would use the invention by inputting the necessary information into Item #1 and then utilizing the control to start the procedure, if any of this were not to happen automatically. The user would then view the results in Item #3, and then potentially export them or use them externally in some way. One could imagine the user iteratively invoking the process, in order to refine results or look for other patterns. Also, users may work with subsets of the data (as discussed previously), if they only wish to find lower-level patterns.

The software could be configured to provide automatic notifications to relevant stakeholders at discretionary intervals.

### Additionally

this technology could be used, for example, to produce outputs not necessarily for human consumption. For example, it could be used in quality applications, to isolate defects in manufacturing processes. It also could be used to potentially identify malware or viruses on computer networks, if these entities were to have some sort of patterned effect in a numeric variable.

This invention, as previously stated, can potentially produce summary data for external presentation, such as images, graphs, and data to be used in presentations or webpages.

What is claimed is:

1. An apparatus for isolating performance clusters in longitudinal, transactional data sets, said apparatus comprising:
An arrangement for accepting longitudinal, transactional data sets;
An arrangement for ascertaining categorical information about each transaction;
An arrangement for ascertaining hierarchical relationship between said categories;
An arrangement for ascertaining ordinal information of levels within multiple hierarchies;
An arrangement for determining clusters within hierarchical structure through testing transactional membership in said clusters;
Wherein said clusters are stored in a computer memory;
Wherein said ascertaining arrangement is adapted to:
Check all possible clusters of hierarchical categories;
Automatically determine if a given hierarchical category belongs to an existing cluster or belongs to a novel cluster;
Wherein said arrangement to automatically determine if a hierarchical category belongs to an existing cluster is adapted to:
Using structural information to determine neighboring categories within hierarchical structure;
Use a mathematical procedure to test if transactions within hierarchical category within specified period of an independent quantitative variable are similar enough to a neighboring category to warrant inclusion in that neighboring category;
Said arrangement for determining neighboring categories within hierarchy via:
Logical recursion through each level of each hierarchy;
Said arrangement for determining similarity between categories based on distance metric of a specified dependent variable.

2. The apparatus according to claim 1, wherein said hierarchical arrangement is determined based on an arrangement operable by the user.

3. The apparatus according to claim 1, wherein said specified interval in independent variable based on an arrangement operable by the user.

4. The apparatus according to claim 1, wherein said specified dependent variable based on an arrangement operable by the user.

5. The apparatus according to claim 1, further comprising an arrangement for determining distances according to some metric between each cluster.

6. The apparatus according to claim 1, further comprising an arrangement for determining whether determined cluster should be displayed based on a threshold.

7. The apparatus according to claim 3, wherein said threshold is determined based on an arrangement operable by the user.

8. A program storage device readable by machine, tangibly embodying a program of instructions executed by the machine to perform method steps for performing hierarchical, categorical clustering, said method comprising the steps of:
An arrangement for accepting longitudinal, transactional data sets;
An arrangement for ascertaining categorical information about each transaction;
An arrangement for ascertaining hierarchical relationship between said categories;
An arrangement for ascertaining ordinal information of levels within multiple hierarchies;
An arrangement for determining clusters within hierarchical structure through testing transactional membership in said clusters;
Wherein said clusters are stored in a computer memory;
Wherein said ascertaining arrangement is adapted to:
Check all possible clusters of hierarchical categories;
Automatically determine if a given hierarchical category belongs to an existing cluster or belongs to a novel cluster;
Wherein said arrangement to automatically determine if a hierarchical category belongs to an existing cluster is adapted to:
Using structural information to determine neighboring categories within hierarchical structure;
Use a mathematical procedure to test if transactions within hierarchical category within specified period of an independent quantitative variable are similar enough to a neighboring category to warrant inclusion in that neighboring category;
Said arrangement for determining neighboring categories within hierarchy via:
Logical recursion through each level of each hierarchy;
Said arrangement for determining similarity between categories based on distance metric of a specified dependent variable.
